(19) United States
(12) Patent Application Publication
(10) Pub. No.: US 2025/0198701 A1
(43) Pub. Date: Jun. 19, 2025

(54) Spiral Baffle System

(71) Applicant: LG Chem, Ltd., Seoul (KR)

(72) Inventors: Dae Hun Kim, Daejeon (KR); Jun Seok Nho, Daejeon (KR); Kyung Hoon Min, Daejeon (KR)

(73) Assignee: LG Chem, Ltd., Seoul (KR)

(21) Appl. No.: 18/848,321

(22) PCT Filed: Oct. 20, 2023
(86) PCT No.: PCT/KR2023/016369

§ 371 Date: Sep. 18, 2024

(30) Foreign Application Priority Data
Nov. 7, 2022 (KR) 10-2022-0146755

(51) Int. Cl. F27B 7/18; F27B 7/33

(52) U.S. Cl. CPC F27B 7/18; F27B 7/33

(57) ABSTRACT

The present disclosure relates to a spiral baffle system that can adjust the pitch of spiral baffles installed to be spaced apart along the longitudinal direction in the housing during the process of mixing and heating a treatment object inputted and transferred into the housing of the heating furnace.

### TECHNICAL FIELD

The present disclosure claims the benefit of the filing date of Korean Patent Application No. 10-2022-0146755 submitted to the Korean Intellectual Property Office on Nov. 7, 2022, the entire contents of which are included in the present disclosure.

The present disclosure relates to a spiral baffle system for a heating furnace, that can adjust the pitch of spiral baffles installed to be spaced apart along the longitudinal direction of the inside of the housing during the process of mixing and heating powders inputted and transferred into the housing of the heating furnace.

### BACKGROUND ART

In general, a rotary kiln (hereinafter referred to as ‘heating furnace’), a type of heating furnace, is a rotary kiln with a cylindrical horizontal frame, which performs processes of mixing, heating, and transferring powder (hereinafter referred to as ‘treatment object’) through the rotation of an inclined cylinder.

Specifically, referring to FIG. 1, the heating furnace is formed in a cylindrical shape having an input port 11 provided in one side of the housing 10 and a discharge port 13 provided in the other side thereof, and the other side of the housing 10 is disposed horizontally to be downwardly inclined at a predetermined angle.

The housing 10 receives power of a motor and rotates at a predetermined speed, and the treatment object inputted through the input port 11 of one side is transferred along a longitudinal direction inclined downward by the rotation of the housing 10. The transferred treatment object is heated by a heat source inside or outside the housing 10 and then discharged to the outside through the discharge port 13 of the other side of the housing 10.

In this case, spiral baffles 20 are disposed on the inner peripheral surface of the housing 10 so as to be spaced apart at regular intervals along the longitudinal direction of the housing 10. Such spiral baffles 20 may not only allow first-in, first-out of the treatment object in the housing 10, but also maintain an appropriate height of the treatment object.

However, in the conventional spiral baffles 20 applied in the heating furnace, the pitch in the longitudinal direction of the housing 10 is in a state of being fixed by welding through a plurality of fixing brackets 21. Accordingly, when the residence time of the treatment object in the housing 10 is changed, there is a problem in that the rotation speed of the housing 10 to reach the target residence time may exceed the usable range of the motor. If the pitch of the spiral baffles 20 needs to be changed to solve such a problem, a lot of time and money may be incurred as the welded portion of the fixing bracket 21 must be removed one by one.

### DISCLOSURE

### Technical Problem

The present disclosure is intended to solve the above-mentioned problems, and an object of the present disclosure is to provide a spiral baffle system that may adjust the pitch of spiral baffles installed to be spaced apart along the longitudinal direction in the housing during the process of mixing and heating the treatment object inputted and transferred into the housing of the heating furnace.

### Technical Solution

A spiral baffle system for a heating furnace according to the present disclosure for realizing the above-described object may include spiral baffles that are coupled to the inner peripheral surface of the housing of the hollow cylindrical heating furnace through fixing brackets so that the spiral baffles mix and transfer a treatment object input, and spacers that are detachably interposed between the fixing brackets and the coupling surfaces of the spiral baffles, and have a predetermined thickness to adjust the pitch of the spiral baffles.

In this case, the spiral baffles may be installed in plural so as to be spaced apart at predetermined intervals along the longitudinal direction of the housing.

Further, the spacers, which are in plural, may have different thicknesses.

Further, at least one spacer corresponding to a pitch set in the spiral baffles among the plurality of spacers may be selectively coupled and configured.

Further, the spacers may be coupled to one end portions of the spiral baffles in the circumferential direction.

Further, the spacer may include a first body which is interposed between the fixing bracket and the spiral baffle, and in which a first insertion hole communicating with the fastening hole of the fixing bracket is formed, and a second body which is disposed on the opposite side of the first body with the spiral baffle being between the first body and the second body, and in which a second insertion hole communicating with the first insertion hole of the first body is formed.

Further, the opposing surfaces of the first body and the second body that are in surface contact with the spiral baffle may be formed as inclined surfaces corresponding to the installation angle of the spiral baffle.

Further, the opposing surfaces of the first body and the second body that are in surface contact with the spiral baffle may have a close contact port with a predetermined thickness, which is formed of a soft synthetic resin material, interposed therebetween.

Further, the spiral baffle system for a heating furnace may further include fasteners that are sequentially fastened to the spiral baffles and the spacers through the fastening holes of the fixing brackets to fix the positions of the spiral baffles.

### Advantageous Effects

The spiral baffle system for a heating furnace according to the present disclosure configured as described above can easily adjust the pitch of the spiral baffles installed to be spaced apart along the longitudinal direction in the housing during the process of mixing and heating the treatment object inputted and transferred into the housing constituting the heating furnace.

In particular, when conditions change such as the residence time of the treatment object being changed in the housing, the treatment object can reach the target residence time through adjustment of the pitch of the spiral baffles.

### DESCRIPTION OF DRAWINGS

FIG. 1 shows a side view showing the configuration of a conventional heating furnace.

FIG. 2 shows a partially cut-away perspective view of a heating furnace provided with a spiral baffle system according to the present disclosure.

FIG. 3 shows a perspective view of a spiral baffle according to the present disclosure.

FIG. 4 shows an exploded perspective view of a spiral baffle system according to the present disclosure.

FIG. 5 shows a side cross-sectional view showing the coupling structure of the spiral baffle system according to the present disclosure.

FIG. 6 shows an exploded perspective view of a spacer according to the present disclosure.

FIGS. 7(A) to 7(C) show state diagrams in which the spacer according to the present disclosure is formed at various thicknesses.

FIGS. 8(A) and 8(B) show side views showing a state in which spiral baffles according to the present disclosure are set to different pitches.

FIG. 9 shows a side cross-sectional view of a state that a close contact port is added to the spiral baffle system according to the present disclosure.

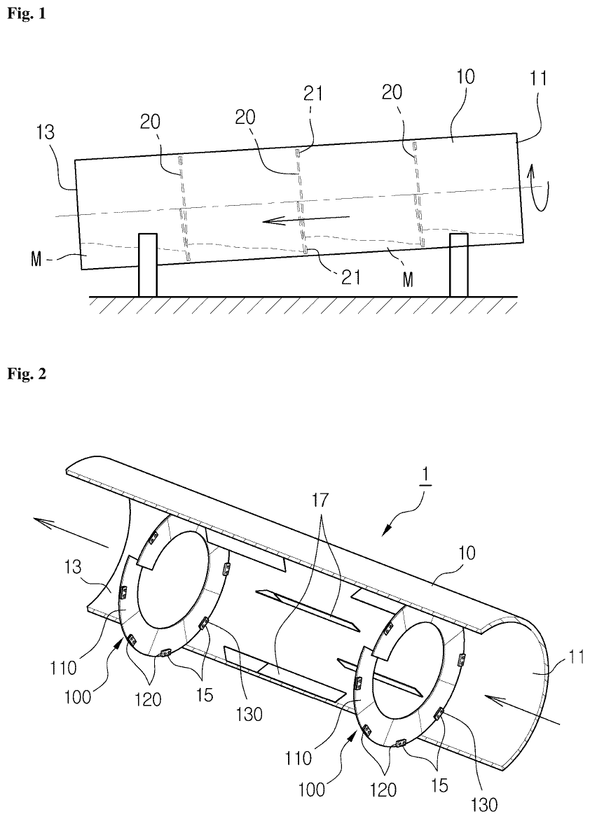

### BEST MODE

Hereinafter, the configuration and operation for specific embodiments of the present disclosure will be described in detail with reference to the accompanying drawings.

Here, in adding reference numerals to components in each drawing, it should be noted that identical components are indicated with the same reference numerals as much as possible, even if they are shown in different drawings.

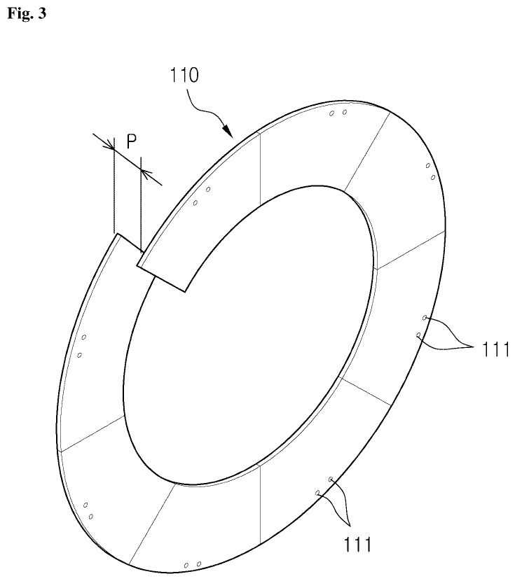

FIG. 2 is a partially cut-away perspective view of a heating furnace provided with a spiral baffle system according to the present disclosure, and FIG. 3 is a perspective view of a spiral baffle according to the present disclosure.

Referring to FIG. 2, the present disclosure relates to a spiral baffle system 100 provided in the housing 10 of a heating furnace 1 that performs a mixing and heating process of the treatment object input and transferred, and such a spiral baffle system 100 may include a spiral baffle 110 and a spacer 120.

For reference, the housing 10 may be formed in the shape of a hollow cylinder. In addition, the housing 10 may be installed to be inclined downward at a predetermined angle toward the discharge port 13 side so that the treatment object input through the input port 11 of one side can be easily discharged through the discharge port 13 of the other side.

A detailed description of such a configuration of the present disclosure is as follows.

First, the spiral baffle 110 is fixed to the inner peripheral surface of the housing 10 constituting the heating furnace 1 via a fixing bracket 15 disposed radially relative to the central axial line, and such a spiral baffle 110 may be installed in plural so as to be spaced apart at predetermined intervals along the longitudinal direction of the housing 10.

Specifically, referring to FIG. 3, the spiral baffle 110 is formed in a ring shape with at least one side open, and both open ends of the spiral baffle 110 are spaced apart to a predetermined pitch P along the longitudinal direction of the housing 10, and thus the body of the spiral baffle 110 may be formed in a spiral shape.

The spiral baffle 110 of such a configuration may be detachably coupled to a plurality of radially disposed fixing brackets 15 via fasteners 130 (see FIG. 2), which will be described later.

In this case, the edge of the spiral baffle 110 may be correspondingly provided with through holes 111 communicating with the fastening holes 15a of the fixing brackets 15 to enable fastening of the fasteners 130.

Meanwhile, a plurality of guide wings 17 may be provided on the inner peripheral surface of the housing 10 to be spaced apart at a predetermined angle relative to the central axial line. In addition, the guide wings 17 may be disposed to cross each other along the longitudinal direction. Accordingly, the treatment object M toward the discharge port 13 side may be uniformly transferred through the guide wings 17, and it may also be possible to prevent the transferred treatment object M from leaning to one side.

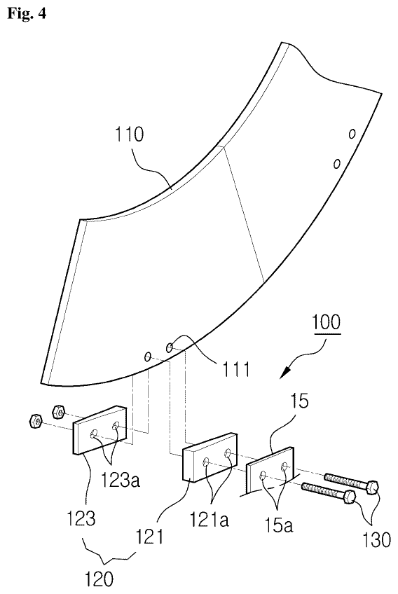

Referring to FIG. 4, the spacer 120 can adjust the pitch P of the spiral baffle 110 to correspond to the changing residence time of the treatment object M during the treatment process of the treatment object M in the heating furnace 1. Such a spacer 120 may be detachably interposed between the fixing bracket 15 and the coupling surface of the spiral baffle 110.

In addition, the spacer 120 may be coupled to one end portion of the spiral baffle 110 in the circumferential direction. That is, since the spacer 120 is coupled to one end portion of the spiral baffle 110 extending in a spiral shape, the pitch P of the spiral baffle 110 can be easily changed.

In this case, materials of the spacer 120 such as heat-resistant synthetic resin or metal can be variously applied. Therefore, there is no particular limitation on the material of the spacer 120 in the present disclosure.

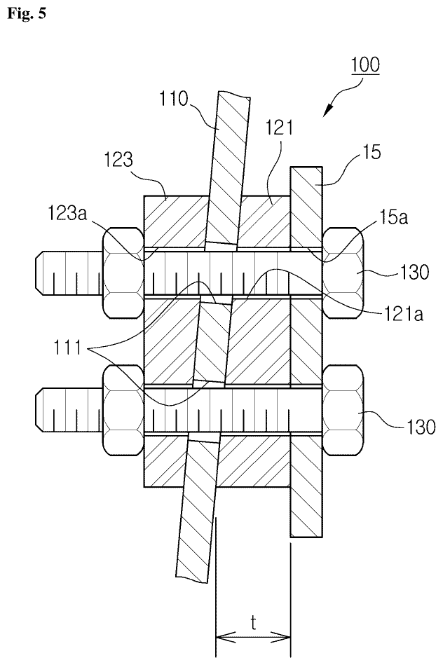

Specifically, referring to FIG. 5, the spacer 120 may include a first body 121 which is interposed between the fixing bracket 15 and the spiral baffle 110, and in which a first insertion hole 121a that communicates with the fastening hole 15a of the fixing bracket 15 is formed, and a second body 123 which is disposed on the opposite side of the first body 121 with the spiral baffle 110 being formed between the first body 121 and the second body 123, and in which a second insertion hole 123a that communicates with the first insertion hole 121a of the first body 121 is formed.

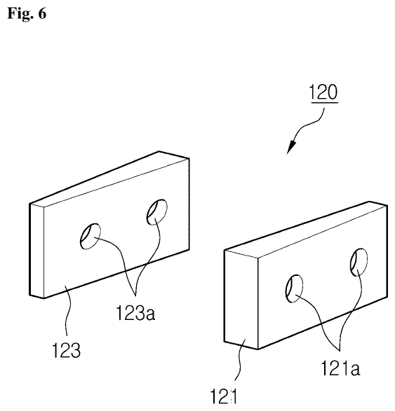

Referring to FIG. 6, opposing surfaces of the first body 121 and the second body 123, which are in surface contact with both side surfaces of the spiral baffle 110, may be formed as inclined surfaces corresponding to the installation angle of the spiral baffle 110.

A plurality of such spacers 120 may be provided with different thicknesses. Accordingly, the spiral baffle 110 can be adjusted to a desired pitch P by a method of selectively combining at least one of the plurality of spacers 120 that corresponds to the set pitch P of the spiral baffle 110.

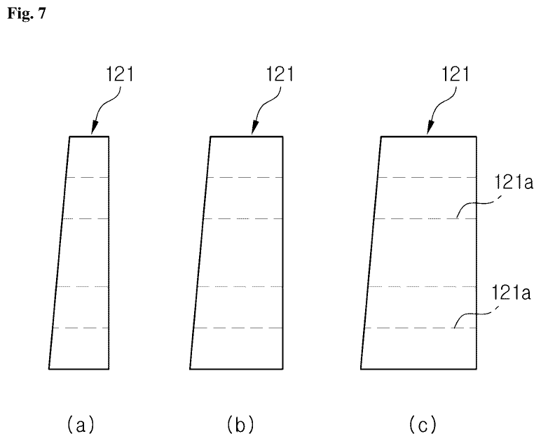

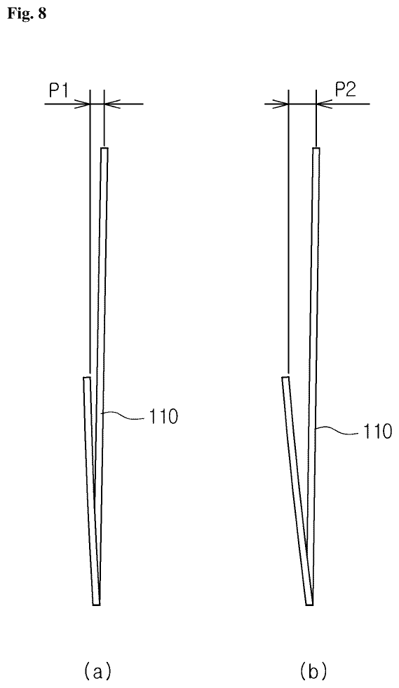

Referring to FIG. 7, the first body 121 from the first body 121 and the second body 123 in the spacer 120 may be formed in plural to have different thicknesses t. In this way, the spiral baffle 110 can be adjusted to various pitches P1 and P2 as shown in FIG. 8 by selectively applying one of the plurality of first bodies 121 formed with different thicknesses t to the spiral baffle 110.

In this case, the spacer 120 can be applied so that the thickness (t) of the first body 121 gradually increases along the spiral direction of the spiral baffle 110, and accordingly, the pitch P of the spiral baffle 110 can be easily adjusted.

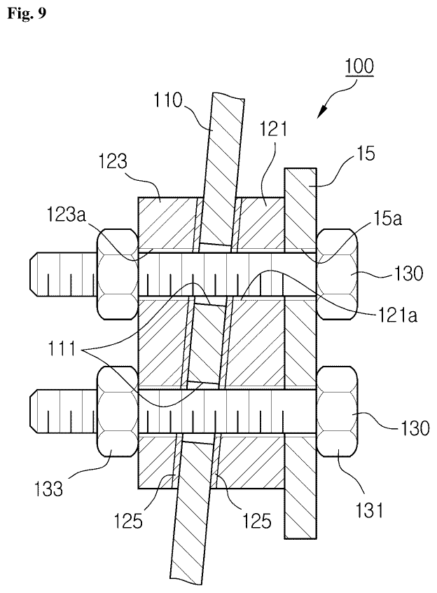

Referring to FIG. 9, a close contact port 125 with a predetermined thickness may be interposed between the opposing surfaces of the first body 121 and the second body 123 that are in surface contact with the spiral baffle 110 to prevent the lifting phenomenon of the contact surface.

In this case, the close contact port 125 may be formed in a size corresponding to the first and second bodies 121 and 123. In addition, the close contact port 125 is preferably formed of a soft synthetic resin material so that it can be in close contact between the opposing surfaces of the first and second bodies 121 and 123.

The fastener 130 fixes the spacer 120 interposed between the fixing bracket 15 and the spiral baffle 110, and the fastener 130 may be composed of bolts 131 and nuts 133 as shown in the drawing, or a structure in which the bolts 131 are screw-coupled without separate nuts 133 may be applied. In the present disclosure, the structure of the fastener 130 is not particularly limited.

Such a fastener 130 is sequentially fastened to the spiral baffle 110 and the first body 121, and to the spacer 120 and the second body 123 through the fastening hole 15a of the fixing bracket 15 so that the position of the spiral baffle 110 can be firmly fixed.

The spiral baffle system 100 for a heating furnace according to the present disclosure of the configuration as described above can easily adjust the pitch P of the spiral baffles 110 installed to be spaced apart along the longitudinal direction in the housing 10 during the process of mixing and heating the treatment object M inputted and transferred into the housing 10 constituting the heating furnace 1.

Accordingly, when conditions change, such as changes in the residence time of the treatment object M in the housing, the pitch P of the spiral baffles 110 can be adjusted to ensure that the treatment object M can reach the target residence time.

In the above, the present disclosure has been shown and described with reference to specified concrete embodiments, but the present disclosure is not limited to the above-described embodiments, and of course, various changes and modifications are possible within the scope that does not depart from the technical spirit of the present disclosure.

[Explanation of reference numerals]

| | | | |
|---|---|---|---|
| 1: | Heating furnace | M: | Treatment object |
| 10: | Housing | 11: | Input port |
| 13: | Discharge port | 15: | Fixing bracket |
| 15a: | Fastening hole | 100: | Spiral baffle system |
| 110: | Spiral baffle | P: | Pitch |
| 120: | Spacer | 121: | First body |
| 121a: | First insertion hole | 123: | Second body |
| 123a: | Second insertion hole | 125: | Close contact port |

| | |
|---|---|
| 130: | Fastener |

1. A variable pitch spiral baffle system, comprising:
spiral baffles that are coupled to an inner peripheral surface of a housing of a hollow cylindrical heating furnace by fixing brackets, the spiral baffles being configured to mix and transfer a treatment object input; and
spacers that are detachably interposed between the fixing brackets and coupling surfaces of the spiral baffles, the spacers each having a predetermined thickness that is configured to adjust a pitch of the spiral baffles.

2. The variable pitch spiral baffle system of claim 1, wherein the spiral baffles are spaced apart from one another at predetermined intervals along a longitudinal direction of the housing.

3. The variable pitch spiral baffle system of claim 1, wherein the spacers, have different thicknesses from one another.

4. The variable pitch spiral baffle system of claim 3, wherein at least one of the spacers corresponding to the pitch of the spiral baffles is selectively coupled to one of the spiral baffles and configured to set the pitch.

5. The variable pitch spiral baffle system of claim 1, wherein the spacers are coupled to circumferential end portions of the spiral baffles.

6. The variable pitch spiral baffle system of claim 1, wherein each spacer comprises:
a first body which is interposed between one of the fixing brackets and one of the spiral baffles, the first body having a first insertion hole extending therethrough and communicating with the fastening hole of the one of the fixing brackets; and
a second body which is disposed on an opposite side of the first body with the one of the spiral baffles being between the first body and the second body, the second body having a second insertion hole extending therethrough and communicating with the first insertion hole of the first body.

7. The variable pitch spiral baffle system of claim 6, wherein opposing surfaces of the first body and the second body that are in surface contact with the one of the spiral baffles are inclined surfaces that are the same as an installation angle of the one of the spiral baffles.

8. The variable pitch spiral baffle system of claim 7, wherein the opposing surfaces of the first body and the second body that are in surface contact with the one of the spiral baffles interposed therebetween each have a close contact part having a predetermined thickness, the close contact parts each being formed of a soft synthetic resin material.

9. The variable pitch spiral baffle system of claim 1, further comprising fasteners that are fastened to the spiral baffles and the spacers through the fastening holes of the fixing brackets to fix the positions of the spiral baffles relative to the inner peripheral surface of the housing.
